(19) United States
(12) Patent Application Publication
(10) Pub. No.: US 2014/0083580 A1
(43) Pub. Date: Mar. 27, 2014

(54) PROTECTIVE COVERING FOR ARTWORK

(71) Applicant: Debra Blades, Abbotsford (CA)

(72) Inventor: Debra Blades, Abbotsford (CA)

(21) Appl. No.: 14/118,207

(22) PCT Filed: May 17, 2012
(86) PCT No.: PCT/CA2012/050325

§ 371 Date: Nov. 15, 2013

Related U.S. Application Data
(60) Provisional application No. 61/486,777, filed on May 17, 2011.

(51) Int. Cl. B44D 7/00

(52) U.S. Cl. CPC B44D 7/00
USPC 150/154

(57) ABSTRACT

A protective covering for an artwork comprises a first panel having a perimeter and a skirt extending along the perimeter of the first panel. A second panel is removeably received by the skirt. There is a drawstring extending through the skirt. Pulling the drawstring causes the skirt to hug the second panel, thereby allowing the artwork to be securely interposed between the first panel and the second panel.

### CROSS-REFERENCE TO RELATED APPLICATION

This application claims the benefit of provisional application Ser. No. 61/486,777 filed in the United States Patent and Trademark Office on May 17, 2012, the disclosure of which is incorporated herein by reference and priority to which is claimed.

### BACKGROUND OF THE INVENTION

1. Field of the Invention

The present invention relates to a protective covering and, in particular, to a protective covering for protecting artwork.

2. Description of the Related Art

Artists are known to wrap painted canvases in cloth or plastic to protect their artwork during transport. Unfortunately protecting a painted canvas in this manner may have the inadvertent consequence of making the artist appear unprofessional. This may be particularly true when relatively expensive artwork is wrapped in towels or plastic bags for transport to a gallery or private collector. There have accordingly been numerous cases developed for transporting painted canvases. For example, U.S. Pat. No. 4,446,968 issued on May 8, 1984 to Bremer, and the full disclosure of which is incorporated herein by reference, discloses a case having cooperating panels that can be adjusted relative to one another to support various sized canvases.

There however remains a need for an inexpensive protective covering for protecting a painted canvas during transport.

### SUMMARY OF THE INVENTION

It is an object of the present invention to provide an improved protective covering to protect a planar article, for example, artwork.

There is accordingly provided a protective covering for an artwork comprising a first panel having a perimeter and a skirt extending along the perimeter of the first panel. A second panel is removeably received by the skirt. There is a drawstring extending through the skirt. Pulling the drawstring causes the skirt to hug the second panel, thereby allowing the artwork to be securely interposed between the first panel and the second panel.

There is also provided a protective covering for an artwork comprising a first panel having a perimeter and a skirt extending along the perimeter of the first panel. A second panel and a third panel are each removeably received by the skirt. There is a drawstring extending through the skirt and pulling the drawstring causes the skirt to hug the second panel and the third panel, thereby allowing a first one of the artworks to be securely interposed between the first panel and the second panel and a second one of the artworks to be securely interposed between the second panel and the third panel.

The protective covering may include a toggle coupled to the drawstring. The protective covering may also include a handle connected to the first panel, the skirt, or both. The first panel may include a padded surface and the skirt may extend outwardly of the padded surface of the first panel. The second panel may include a padded surface and may be quilted. The third panel may include a padded surface and may be quilted. The drawstring may extend along a mouth of the skirt.

### BRIEF DESCRIPTIONS OF DRAWINGS

The invention will be more readily understood from the following description of the embodiments thereof given, by way of example only, with reference to the accompanying drawings, in which:

FIG. 1 is a front view of a first embodiment of an improved protective covering for protecting a painted canvas during transport;

FIG. 2 is a rear view of the protective covering of FIG. 1 showing the protective covering in an open configuration;

FIG. 3 is a rear view of the protective covering of FIG. 1 showing a painted canvas disposed in the protective covering;

FIG. 4 is a rear view of the protective covering of FIG. 1 showing the protective covering in a closed configuration;

FIG. 5 is a front view of a bag which may be used for carrying the protective covering of FIG. 1;

FIG. 6 is a side view of a second embodiment of an improved protective covering for protecting a painted canvas during transport;

FIG. 7 is a plan view of a strap for the protective covering of FIG. 6; and

FIG. 8 is a front view of the improved protective covering of FIG. 6 together with the strap of FIG. 7.

### DESCRIPTIONS OF THE PREFERRED EMBODIMENTS

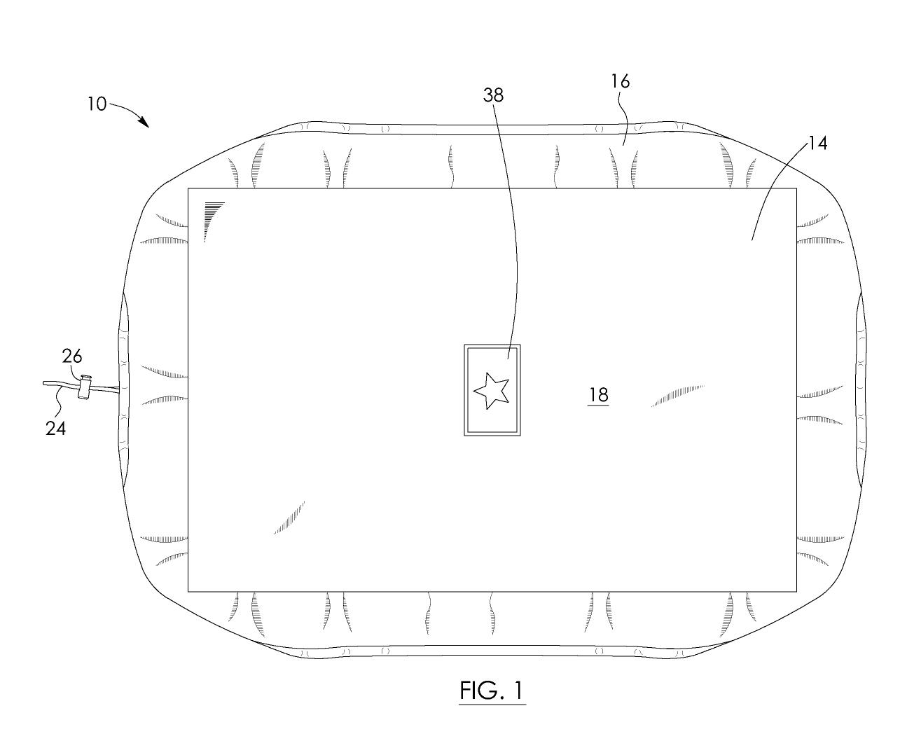

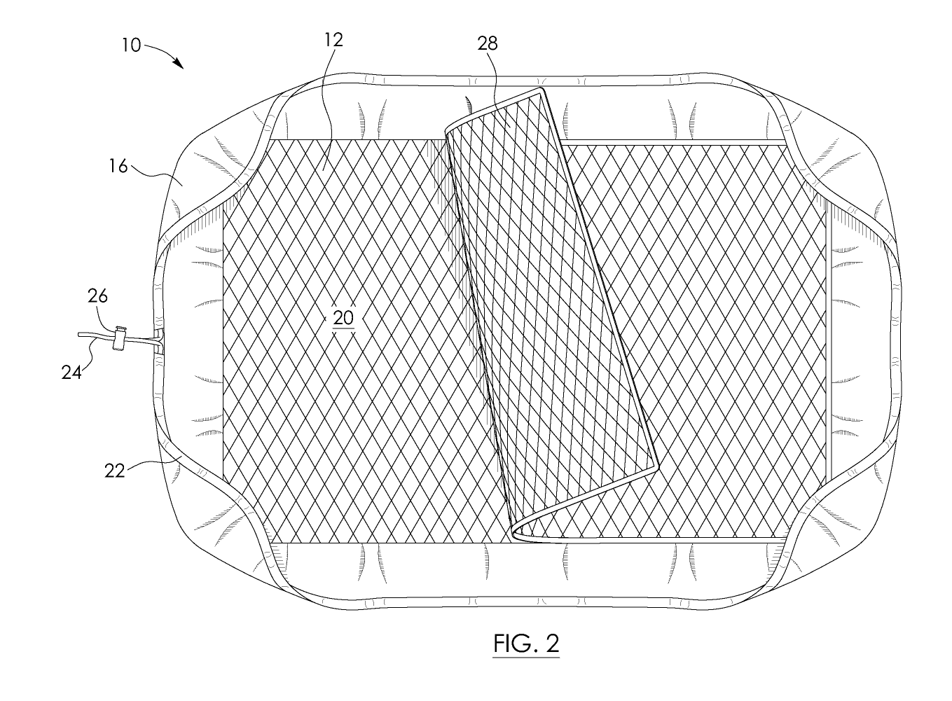

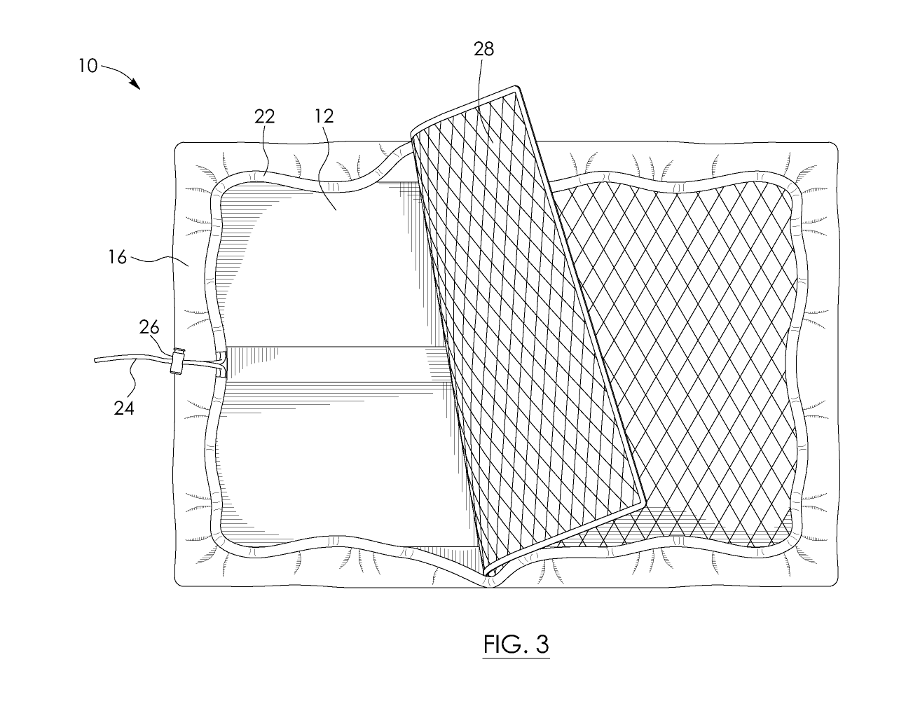

Referring to the drawings and first to FIG. 1, this shows a front view of a first embodiment of an improved covering 10 to protect a painted canvas 12 (shown in FIG. 3) or similar artwork, i.e. prints, large photographs, etc. Referring back to FIG. 1, the covering 10 includes a first panel 14, which is rectangular in this example, and a skirt 16 extending along a perimeter of the first panel. In this example, a front face 18 of the first panel 12 is a polyurethane coated nylon face while a rear face 20 of the first panel 12, shown in FIG. 2, is a padded diamond quilt backing. As shown in FIG. 2, there is a drawstring 24 which extends through the skirt 16 along a mouth 22 thereof. The drawstring 24 is provided with a toggle 26. The covering also includes a second panel 28 which, in this example, is a diamond quilt similar in size and shape as to the first panel 14. The first panel 14 and second panel 28 may be of varying sizes and shapes to accommodate painted canvases or other artwork of varying sizes and shapes.

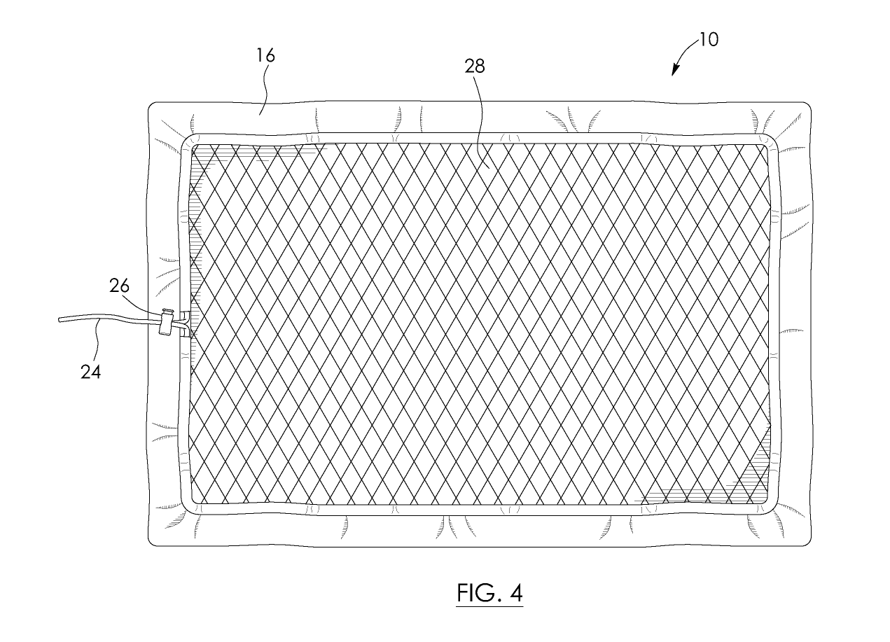

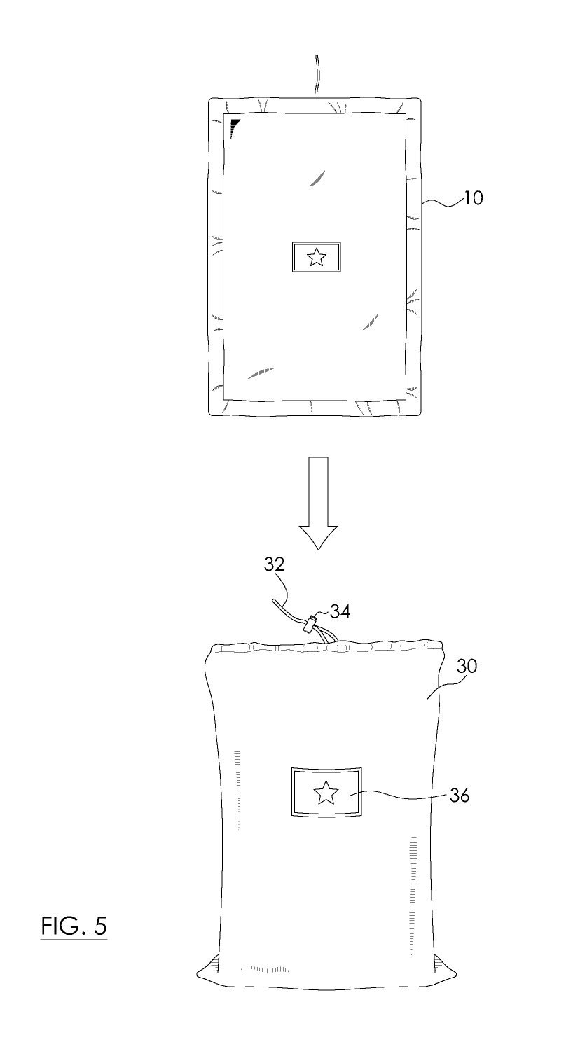

In operation, and as best shown in FIG. 3, the painted canvas 12 is laid face first onto the first panel 14 and the second panel 28 is received by the skirt 16 and laid over the painted canvas 12 supported on the first panel 14. The painted canvas 12 is thereby sandwiched between the first panel 14 and the second panel 28. The drawstring 24 is then pulled and locked with the toggle 26 causing the skirt 16 to hug the painted canvas 12 which is sandwiched between the first panel 14 and the second panel 28. The painted canvas 12 is thereby securely retained in the covering. This is best shown in FIG. 4. The covering 10 and painted canvas 12 may be placed in a bag 30, shown in FIG. 5, for transport. In this example, the bag 30 is provided with a drawstring 32 and toggle 34 which allow the bag to be closed. A logo 36 may also be printed onto the bag for promotional purposes. As shown in FIG. 1, a logo 38 may also be printed onto the front face 18 of the first panel 12.

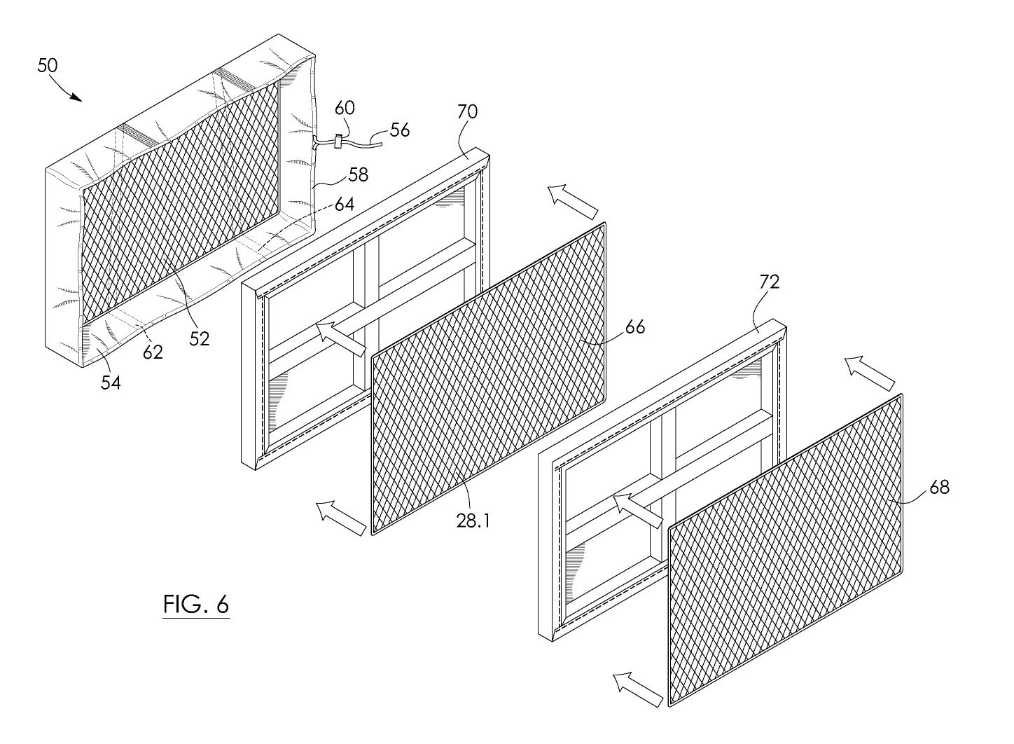

Referring now to FIG. 6, a second embodiment of an improved protective covering 50 for protecting a painted canvas during transport is shown.

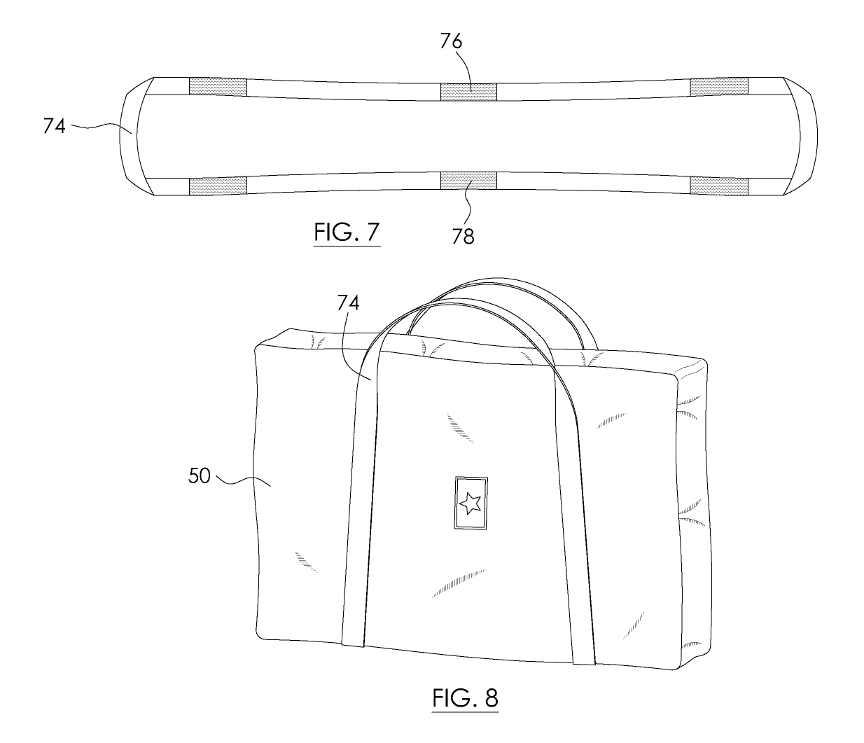

The covering 50 includes a first panel 52, which is rectangular in this example, and a skirt 54 extending along a perimeter of the first panel. There is a drawstring 56 which extends through the skirt 54 along a mouth 58 thereof. The drawstring 56 is provided with a toggle 60. The covering 50 is also provided with fasteners in the form of hook and loop fastener strips 62 and 64 of the type sold under the trademark VELCRO® disposed on the first panel 52 and skirt 54. This allows a handle 74, shown in FIG. 7, to be secured to the covering 50. In this example, the handle 74 is an endless handle provided with corresponding fasteners, also in the form of hook and loop fastener strips 76 and 78, which allow the handle 74 to be secured to the covering 50 as shown in FIG. 8 where the handle 74 receives the covering 50 in a cradle like manner. It will be understood by a person skilled in the art that in other embodiments other types of fasteners and handles may be provided or the handle may be fixedly secured to the covering 50.

Referring back to FIG. 6, the covering also includes a second panel 66 and a third panel 68 which, in this example, are diamond quilts similar in size and shape as to the first panel 52. The second panel 66 and third panel 68 allow artworks 70 and 72 to be stacked and covered by the protective covering 50. A first one of the artworks 70 will be securely interposed between the first panel 52 and the second panel 66. A second one of the artworks 72 will be securely interposed between the second panel 66 and the third panel 68.

It will be understood by a person skilled in the art that providing further panels similar to the second panel and third panel may allow further painted canvases to be stacked on each other and protected with each painted canvas being interposed between corresponding ones of the panels.

It will also be understood by a person skilled in the art that although the planar article covered by the protective covering in this example is artwork, that in other examples other planar articles including, but not limited to, flat screens and panes of glass, may be covered and transported using the protective covering.

It will further be understood by a person skilled in the art that many of the details provided above are by way of example only, and are not intended to limit the scope of the invention which is to be determined with reference to the following claims.

What is claimed is:

1. A protective covering for an artwork:
a first panel having a perimeter and a skirt extending along the perimeter of the first panel; and
a second panel removeably received by the skirt, wherein there is a drawstring extending through the skirt and pulling the drawstring causes the skirt to hug the second panel thereby allowing the artwork to be securely interposed between the first panel and the second panel.

2. The protective covering as claimed in claim 1 further including a toggle coupled to the drawstring.

3. The protective covering as claimed in claim 1 further including a handle connected to the first panel.

4. The protective covering as claimed in claim 1 further including a handle connected to the skirt.

5. The protective covering as claimed in claim 1 wherein the first panel includes a padded surface and the skirt extends outwardly of the padded surface.

6. The protective covering as claimed in claim 1 wherein the second panel includes a padded surface.

7. The protective covering as claimed in claim 1 wherein the second panel is quilted.

8. The protective covering as claimed in 1 wherein the drawstring extends along a mouth of the skirt.

9. A protective covering for a plurality of artworks:
a first panel having a perimeter and a skirt extending along the perimeter of the first panel; and
a second panel and a third panel each removeably received by the skirt, wherein there is a drawstring extending through the skirt and pulling the drawstring causes the skirt to hug the second panel and the third panel thereby allowing a first one of the artworks to be securely interposed between the first panel and the second panel and a second one of the artworks to be securely interposed between the second panel and the third panel.

10. The protective covering as claimed in claim 1 further including a toggle coupled to the drawstring.

11. The protective covering as claimed in claim 1 further including a handle connected to the first panel.

12. The protective covering as claimed in claim 1 further including a handle connected to the skirt.

13. The protective covering as claimed in claim 1 wherein the first panel includes a padded surface and the skirt extends outwardly of the padded surface.

14. The protective covering as claimed in claim 1 wherein the second panel includes a padded surface.

15. The protective covering as claimed in claim 1 wherein the second panel is quilted.

16. The protective covering as claimed in claim 1 wherein the second panel includes a padded surface.

17. The protective covering as claimed in claim 1 wherein the second panel is quilted.

18. The protective covering as claimed in 1 wherein the drawstring extends along a mouth of the skirt.

19. In combination:
a first artwork;
a second artwork; and
a protective covering for the first artwork and the second artwork, the protective covering including:
a first panel having a perimeter and a skirt extending along the perimeter of the first panel; and
a second panel and a third panel each removeably received by the skirt, wherein there is a drawstring extending through the skirt and pulling the drawstring causes the skirt to hug the second panel and the third panel thereby allowing the first artwork to be securely interposed between the first panel and the second panel and the second artwork to be securely interposed between the second panel and the third panel.
